(19) United States
(12) Patent Application Publication
(10) Pub. No.: US 2012/0295020 A1
(43) Pub. Date: Nov. 22, 2012

(54) Optical Member and Preparation Method Thereof

(76) Inventors: Doo Jin Park, Yongin-si (KR); Ji Hwan Park, Yongin-si (KR); Seok Il Yoon, Seo-gu (KR); Hun Soo Oh, Pyeongtaek-si (KR); Dong Jin Jung, Osan-si (KR); Ki Wan Baek, Hwaseong-si (KR); Jae Hoon Kim, Buk-gu (KR); Ki Seop Kim, Gwangju-si (KR); Jong Kil Kim, Buyeo-gun (KR)

(21) Appl. No.: 13/574,583

(22) PCT Filed: Jan. 18, 2011
(86) PCT No.: PCT/KR2011/000350

§ 371 Date: Jul. 20, 2012

(30) Foreign Application Priority Data
Jan. 26, 2010 (KR) 1020100007119

(51) Int. Cl. B05D 5/06; G02B 5/02

(52) U.S. Cl. 427/163.4

(57) ABSTRACT

The present invention relates to a preparation method of an optical member, comprising the following steps: coating a a mixture of methyl methacrylate (MMA) and a light diffuser on one surface of a substrate comprising poly methyl methacrylate (PMMA) by a predetermined pattern; polymerizing the coated methyl methacrylate into poly methyl methacrylate to form semi-cured polymethyl methacrylate; and completely curing the semi-cured polymethyl methacrylate, and an optical member prepared thereby.

### TECHNICAL FIELD

The present invention relates to an optical member applicable to a display device, and more particularly, to an optical member with a predetermined pattern, and a method of manufacturing the same.

### BACKGROUND ART

A display device such as a liquid crystal display (LCD) device reproduces an image by way of light emission. Various optical members may be applied to advance the light effectively toward a front surface of the display device with minimizing a loss of the light emitted.

Hereinafter, the optical member applied to the display device, for example, LCD device will be explained as follows.

FIG. 1 is a cross section view illustrating a related art LCD device.

As shown in FIG. 1, the related art LCD device comprises a liquid crystal panel 10 and a backlight unit 20.

The liquid crystal panel 10 comprises a lower substrate, an upper substrate, and liquid crystal. The liquid crystal is formed between the lower substrate and the upper substrate. The light passing through the liquid crystal panel 10 is controlled by driving the liquid crystal, thereby reproducing the image.

The backlight unit 20 comprises a light source 22, a light-guiding plate 24, and an optical sheet 26. The light emitted from the light source 22 advances toward the inside of the liquid crystal panel 10 via the light-guiding plate 24 and the optical sheet 26.

The light source 22 is positioned at a lateral side of the light-guiding plate 24, wherein the light source 22 emits the light toward the lateral side of the light-guiding plate 24.

The light-guiding plate 24 guides the light emitted from the light source 22 toward the liquid crystal panel 10.

The optical sheet 26 uniformly transmits the light guided by the light-guiding plate 24 to the liquid crystal panel 100. The optical sheet 26 may be obtained by combination of plural sheets such as diffusion sheets and prism sheets.

The light-guiding plate 24 has such a pattern as to change a light path. That is, the light incident on the lateral side of the light-guiding plate 24 advances toward the front side owing to the pattern of the light-guiding plate 24. Also, the diffusion sheet and the prism sheet constituting the optical sheet 26 have a predetermined pattern so that the light incident from their lower sides is adjusted to a needed shape.

The optical member such as the light-guiding plate 24 and the optical sheet 26 functions well owing to the predetermined pattern formed therein. A related art method of forming the predetermined pattern will be explained with reference to the example of the light-guiding plate 24.

The light-guiding plate 24 is formed of a plate of a transparent material allowing a light transmission, wherein a predetermined pattern for changing a light path is formed on a surface of the plate.

A related art method of forming the pattern may use a laser-cutting method or a printing method.

The laser-cutting method is to provide a predetermined pattern by forming grooves in a surface of the plate by the use of laser. This laser-cutting method is disadvantageous in that it causes scraps, and it takes a long time for a pattern forming process, to thereby deteriorate the yield.

The printing method is to provide a predetermined pattern by coating a special ink onto a surface of the plate by the use of mask having a predetermined pattern. This printing method requires a periodic replacement of a mask depending on a mask lifespan, whereby a manufacturing cost is increased. Also, since the plate is formed of the different material from the ink used for formation of the pattern on the plate, there is difference in light refraction between the plate and the ink. Thus, it might cause problems of a complicated control of light, and a weak adhesive strength between the plate and the ink.

### DETAILED DESCRIPTION

### Task to be Solved

Therefore, the present invention has been made in view of the above problems, and it is an aspect of the present invention to provide an optical member and a method of manufacturing the same which is capable of preventing one or more problems of the related art.

An aspect of the present invention is to provide an optical member and a method of manufacturing the same, which facilitates to simply form a pattern composed of the same material in a relatively short time, and also prevents problems related with a difference of light refraction and a weak adhesive strength.

### Technical Solution

To achieve these objects and other advantages and in accordance with the purpose of the invention, as embodied and broadly described herein, there is provided a method of manufacturing an optical member comprising: coating a predetermined pattern using a mixture of methyl methacrylate (MMA) and light-diffusing agent onto one surface of a substrate of poly methyl methacrylate (PMMA); forming half-cured poly methyl methacrylate (PMMA) by polymerizing the methyl methacrylate (MMA) into the poly methyl methacrylate (PMMA); and completely curing the half-cured poly methyl methacrylate (PMMA).

The process of coating the predetermined pattern using the mixture of methyl methacrylate (MMA) and light-diffusing agent comprises: coating the mixture onto the one surface of the substrate; and bring a mold into contact with the mixture coated onto the substrate.

The process of coating the predetermined pattern using the mixture of methyl methacrylate (MMA) and light-diffusing agent comprises: coating the mixture onto a mold with a predetermined pattern; and depositing the substrate on the mixture.

In another aspect of the present invention, there is provided a method of manufacturing an optical member comprising: forming a sealing element in the margin of a lower mold; placing a substrate of poly methyl methacrylate (PMMA) onto the lower mold inside the sealing element; preparing an upper mold with a predetermined pattern, and fixedly providing the upper mold onto the sealing element under the condition that the predetermined pattern of the upper mold faces toward the lower mold; injecting a mixture of methyl methacrylate (MMA) and light-diffusing agent into a space between the lower and upper molds to coat the mixture onto the substrate; forming half-cured poly methyl methacrylate (PMMA) by polymerizing the methyl methacrylate (MMA) into the poly methyl methacrylate (PMMA); and completely curing the half-cured poly methyl methacrylate (PMMA).

The process of injecting the mixture into the space between the lower and upper molds is carried out by injecting the mixture via an inlet portion provided at one side of the sealing element between the lower and upper molds; and air remaining in the space between the lower and upper molds is discharged via an air-discharging portion provided at the other side of the sealing element. In this case, the process of injecting the mixture into the space between the lower and upper molds is carried out under the condition that the lower and upper molds are maintained vertically; and the air-discharging portion is provided at the upper side of the sealing element.

In another aspect of the present invention, there is provided a method of manufacturing an optical member comprising: forming a sealing element in the margin of a lower mold; placing a substrate of poly methyl methacrylate (PMMA) onto the lower mold inside the sealing element; dispensing a mixture of methyl methacrylate (MMA) and light-diffusing agent onto the substrate; preparing an upper mold with a predetermined pattern, and fixedly providing the upper mold onto the sealing element under the condition that the predetermined pattern of the upper mold faces toward the lower mold; forming half-cured poly methyl methacrylate (PMMA) by polymerizing the methyl methacrylate (MMA) into the poly methyl methacrylate (PMMA); and completely curing the half-cured poly methyl methacrylate (PMMA).

The process of polymerizing the methyl methacrylate (MMA) into the poly methyl methacrylate (PMMA), and the process of completely curing the half-cured poly methyl methacrylate (PMMA) comprise submerging the lower and upper molds sealed by the sealing element into a container filled with a predetermined liquid. In this case, the process of submerging the lower and upper molds is carried out under the condition that an end of the air-discharging portion provided in the sealing element is not submerged so as to discharge the air remaining in the sealed inner space between the lower and upper molds to the outside.

The process of polymerizing the methyl methacrylate (MMA) into the poly methyl methacrylate (PMMA) is carried out by a heating process maintained at 30˜100° C. temperature for 60˜120 minutes.

The process of completely curing the half-cured poly methyl methacrylate (PMMA) is carried out by a heating process maintained at 55˜120° C. temperature for 3˜10 minutes.

The light-diffusing agent is formed of a bead-shaped structure.

In another aspect of the present invention, there is provided an optical member comprising: a substrate of poly methyl methacrylate (PMMA); a predetermined pattern layer formed of a mixture of poly methyl methacrylate (PMMA) and light-diffusing agent on one surface of the substrate.

The light-diffusing agent is formed of a bead-shaped structure.

The optical member is a light-guiding plate, a light-diffusion sheet, or a prism sheet.

### Advantageous Effects

According to the present invention, since the optical member is composed of the same material for both of a substrate and a predetermined pattern layer, that is, poly methyl methacrylate (PMMA), the problems related with the difference of light refraction and the weak adhesive strength can be prevented, which enables the precise control of light.

Also, the optical member with the predetermined pattern is manufactured by the use of mold, so that the desired pattern can be simply formed in the optical member in a relatively short time.

Also, the light-diffusing agent is contained in the pattern layer, to thereby enhance the light transmittance.

### DESCRIPTION OF DRAWINGS

FIG. 1 is a cross section view illustrating an LCD device according to the related art.

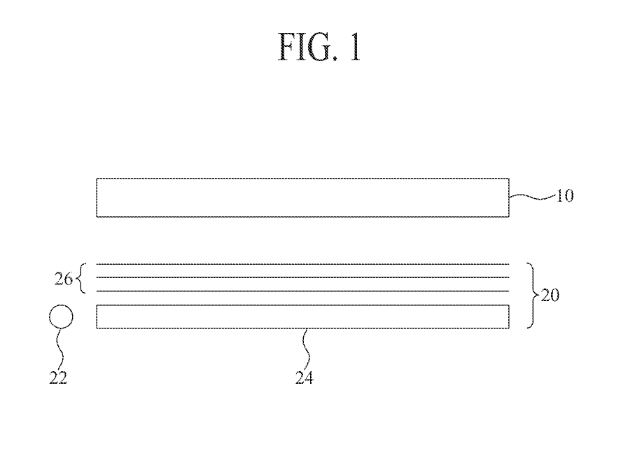

FIGS. 2A to 2D are cross section views illustrating a method of manufacturing an optical member according to the first embodiment of the present invention.

FIGS. 3A to 3D are cross section views illustrating a method of manufacturing an optical member according to the second embodiment of the present invention.

FIGS. 4A to 4F are cross section views illustrating a method of manufacturing an optical member according to the third embodiment of the present invention.

FIGS. 5A to 5F are cross section views illustrating a method of manufacturing an optical member according to the fourth embodiment of the present invention.

FIG. 6A is a cross section view illustrating a process of injecting a mixture of methyl methacrylate (MMA) and light-diffusing agent according to one embodiment of the present invention, and FIG. 6B is a perspective view illustrating a process of injecting a mixture of methyl methacrylate (MMA) and light-diffusing agent according to another embodiment of the present invention.

FIG. 7 is a cross section view illustrating a process of curing methyl methacrylate (MMA) according to one embodiment of the present invention.

### BEST MODE

Reference will now be made in detail to the exemplary embodiments of the present invention, examples of which are illustrated in the accompanying drawings.

### First Embodiment

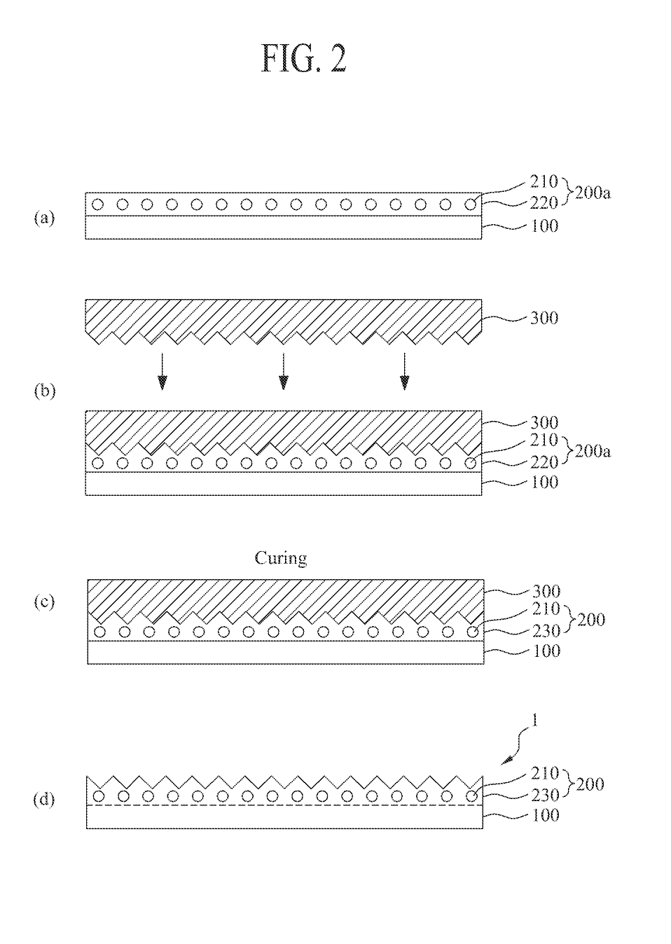

FIGS. 2A to 2D are cross section views illustrating a method of manufacturing an optical member according to the first embodiment of the present invention.

First, as shown in FIG. 2A, a substrate 100 of poly methyl methacrylate (PMMA) is prepared, and one surface of the substrate 100 is entirely coated with a mixture 200a of methyl methacrylate (MMA) 220 and light-diffusing agent 210.

The poly methyl methacrylate (PMMA) composing the substrate 100 is solid-state polymer with good transmittance, which functions as a good optical member.

The light-diffusing agent 210 diffuses light to thereby enhance light transmittance, wherein the light-diffusing agent 210 may be formed of a bead-shaped structure. The light-diffusing agent 210 may be made of oxide such as SnO₂, TiO₂, ZnO₂, SiO₂, or CeO₂.

The methyl methacrylate (MMA) 220 is low molecular weight compound in a liquid-state. Thus, the mixture 200a of methyl methacrylate (MMA) 220 and light-diffusing agent 210 may be coated onto the one surface of the substrate 100 by a method using a nozzle which is generally known to those skilled in the art. If needed, a polymerization initiator or curing agent may be additionally contained in the mixture 200a.

As shown in FIG. 2B, a predetermined-pattern mold 300 is prepared. Then, the predetermined-pattern mold 300 is brought into contact with the mixture 200a coated onto the substrate 100. Thus, the predetermined pattern of the mold 300 is imprinted in the mixture 200a of methyl methacrylate (MMA) 220 and light-diffusing agent 210, to thereby form a corresponding pattern in the mixture 200a of methyl methacrylate (MMA) 220 and light-diffusing agent 210 depending on the shape in the predetermined pattern of the mold 300.

The predetermined pattern of the mold 300 is determined in consideration to a pattern desirous to be finally obtained in the optical member. The pattern may vary in shape of cross section, for example, triangular shape, circle shape, oval shape, and etc. The pattern with this cross section may be changed to various configurations, for example, stripe configuration, matrix configuration, ‘+’-shaped configuration, ‘x’-shaped configuration, ‘T’-shaped configuration, and etc.

As shown in FIG. 2C, the mixture with the aforementioned pattern (See ‘200a’ in FIG. 2B) is cured.

The curing process may comprise forming half-cured poly methyl methacrylate (PMMA) by polymerizing the methyl methacrylate (MMA) into the poly methyl methacrylate (PMMA); and completely curing the half-cured poly methyl methacrylate (PMMA). Accordingly, a pattern layer 200 is formed by the above curing process, wherein the pattern layer 200 is made of the mixture of poly methyl methacrylate (PMMA) 230 and light-diffusing agent 210.

The methyl methacrylate (MMA) being low molecular weight compound in the liquid-state is polymerized into the poly methyl methacrylate (PMMA), whereby it is half-cured to be in a gel state. Thereafter, the half-cured poly methyl methacrylate (PMMA) of the gel state is completely cured. In this case, the half-cured state is not the completely-cured state, but the gel state maintained at a predetermined viscosity.

Preferably, the above process of polymerizing the methyl methacrylate (MMA) into the poly methyl methacrylate (PMMA) to form half-cured poly methyl methacrylate (PMMA) is carried out by a heating process maintained at 30˜100° C. temperature for 60˜120 minutes. If the temperature of the polymerizing process is less than 30° C., the polymerizing process is not smoothly carried out, and furthermore the polymerizing process takes a long time. Meanwhile, if the temperature of the polymerizing process is more than 100° C., a difference in degree of polymerization occurs due to a rapid polymerization reaction so that the optical properties might be un-uniform, and the poly methyl methacrylate (PMMA) might be sagging. If the polymerizing process is less than 60 minutes, the polymerization might be incomplete. Meanwhile, if the polymerizing process is more than 120 minutes, the yield might be deteriorated, and the poly methyl methacrylate (PMMA) might be sagging.

Preferably, the above process of completely curing the half-cured poly methyl methacrylate (PMMA) is carried out by a heating process maintained at 55˜120° C. temperature for 3˜10 minutes. If the temperature of the complete curing process is less than 55° C., it might cause the incomplete curing, and the increase of time consumed for the curing process. Meanwhile, if the temperature of the complete curing process is more than 120° C., the optical properties might be un-uniform due to a rapid polymerization reaction, and the poly methyl methacrylate (PMMA) might be sagging. If the complete curing process is less than 3 minutes, it might cause the incomplete curing. Meanwhile, if the complete curing process is more than 10 minutes, the yield might be deteriorated, and the poly methyl methacrylate (PMMA) might be sagging.

As shown in FIG. 2D, a predetermined optical member 1 is completed by separation of the mold (See ‘300’ of FIG. 2c).

That is, the optical member 1 is obtained in such a way that it contains the predetermined pattern layer 200 composed of the mixture of light-diffusing agent 210 and poly methyl methacrylate (PMMA) 230 on the one surface of the substrate 100 composed of the poly methyl methacrylate (PMMA). Thus, since the substrate 100 and the pattern layer 200 included in the optical member 1 according to the present invention are formed of the same material, that is, poly methyl methacrylate (PMMA), there is no problem related with an adhesive strength between the substrate 100 and the pattern layer 200. Also, in case of the optical member 1 of the present invention, the light-diffusing agent 210 is contained in the pattern layer 200, thereby enhancing the light transmittance.

For the following description about the second to fourth embodiments of the present invention, a detailed explanation for the same parts as those of the first embodiment will be omitted.

### Second Embodiment

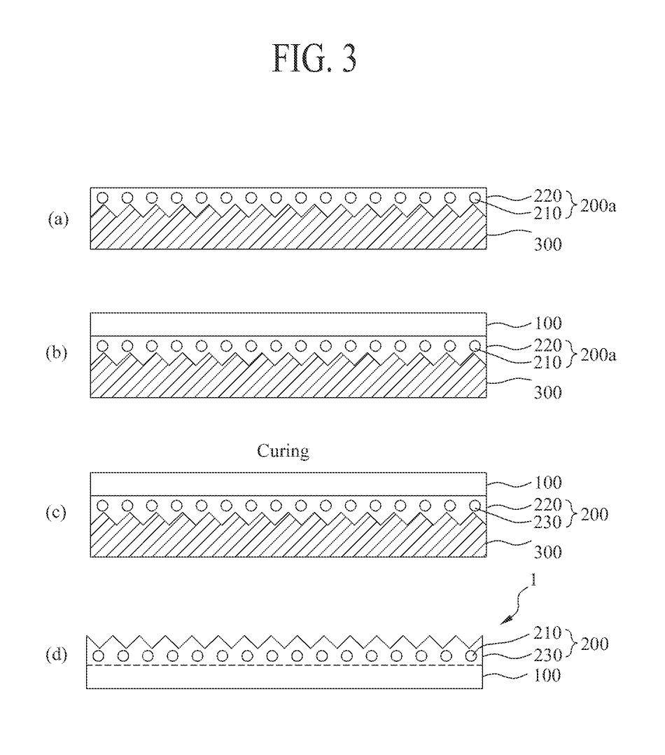

FIGS. 3A to 3D are cross section views illustrating a method of manufacturing an optical member according to the second embodiment of the present invention.

As shown in FIG. 3A, a predetermined-pattern mold 300 is prepared. Then, the predetermined-pattern mold 300 is coated with a mixture 200a of methyl methacrylate (MMA) 220 and light-diffusing agent 210, whereby a corresponding pattern is formed in the mixture 200a of methyl methacrylate (MMA) 220 and light-diffusing agent 210 depending on the shape in the predetermined pattern of the mold 300.

As shown in FIG. 3B, a substrate 100 of poly methyl methacrylate (PMMA) is deposited on the mixture 200a coated onto the mold 300.

As shown in FIG. 3C, the mixture with the aforementioned pattern (See ‘200a’ of FIG. 3B) is cured.

The curing process may comprise forming half-cured poly methyl methacrylate (PMMA) by polymerizing the methyl methacrylate (MMA) into the poly methyl methacrylate (PMMA); and completely curing the half-cured poly methyl methacrylate (PMMA).

Accordingly, a pattern layer 200 is formed by the above curing process, wherein the pattern layer 200 is made of the mixture of poly methyl methacrylate (PMMA) 230 and light-diffusing agent 210.

As shown in FIG. 3D, a predetermined optical member 1 is completed by separation of the mold (See ‘300’ of FIG. 3C).

### Third Embodiment

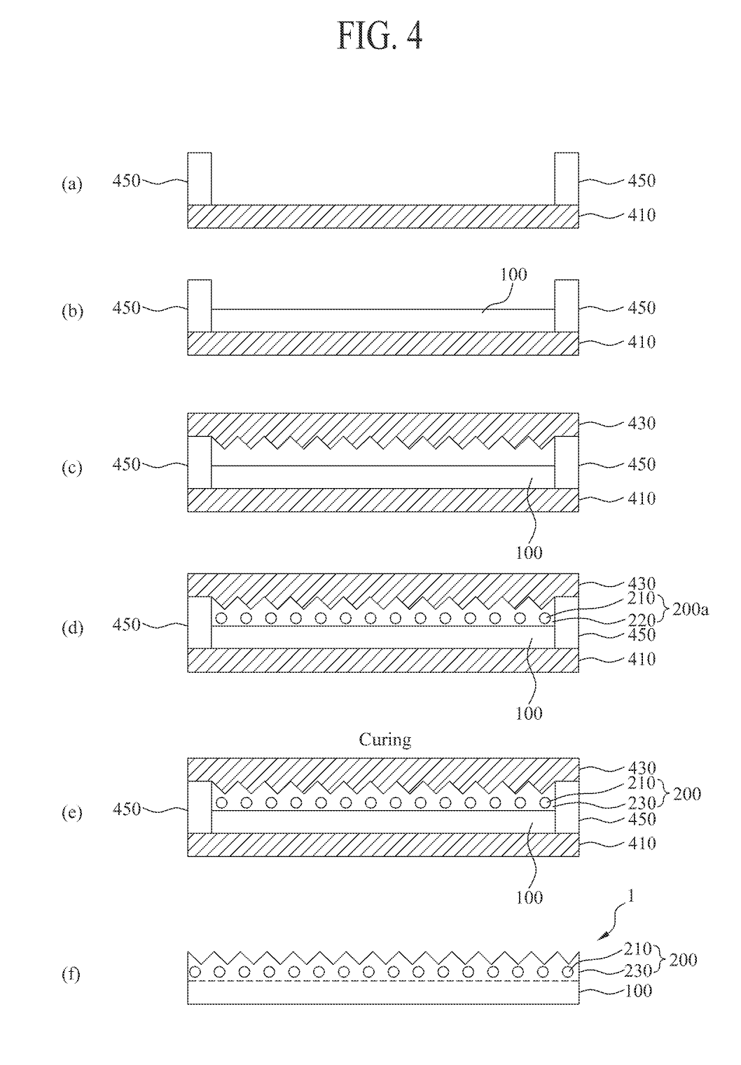

FIGS. 4A to 4F are cross section views illustrating a method of manufacturing an optical member according to the third embodiment of the present invention.

First, as shown in FIG. 4A, a sealing element 450 is formed in the margin of a lower mold 410.

The lower mold 410 may be formed of an even plate, and the sealing element 450 may be fixed to the margin of the lower mold 410 by the use of predetermined adhesive.

As shown in FIG. 4B, a substrate 100 of poly methyl methacrylate (PMMA) is placed onto the lower mold 410 while being positioned inside the sealing element 450.

As shown in FIG. 4C, an upper mold 430 with a predetermined pattern is prepared. Under the condition that the predetermined pattern of the upper mold 430 faces toward the lower mold 410, the upper mold 430 is fixedly provided onto the sealing element 450.

The pattern of the upper mold 430 is determined in consideration to a pattern desirous to be finally obtained in the optical member. The lower and upper molds 410 and 430 are fixedly provided by the sealing element 450 so that a sealed inner space is formed therebetween.

As shown in FIG. 4D, a mixture 200a of methyl methacrylate (MMA) 220 and light-diffusing agent 210 is injected into the sealed inner space between the lower and upper molds 410 and 430, whereby the mixture 200a is coated onto the substrate 100 of poly methyl methacrylate (PMMA). In this case, the mixture 200a is coated in such a pattern as to correspond to the pattern of the upper mold 430.

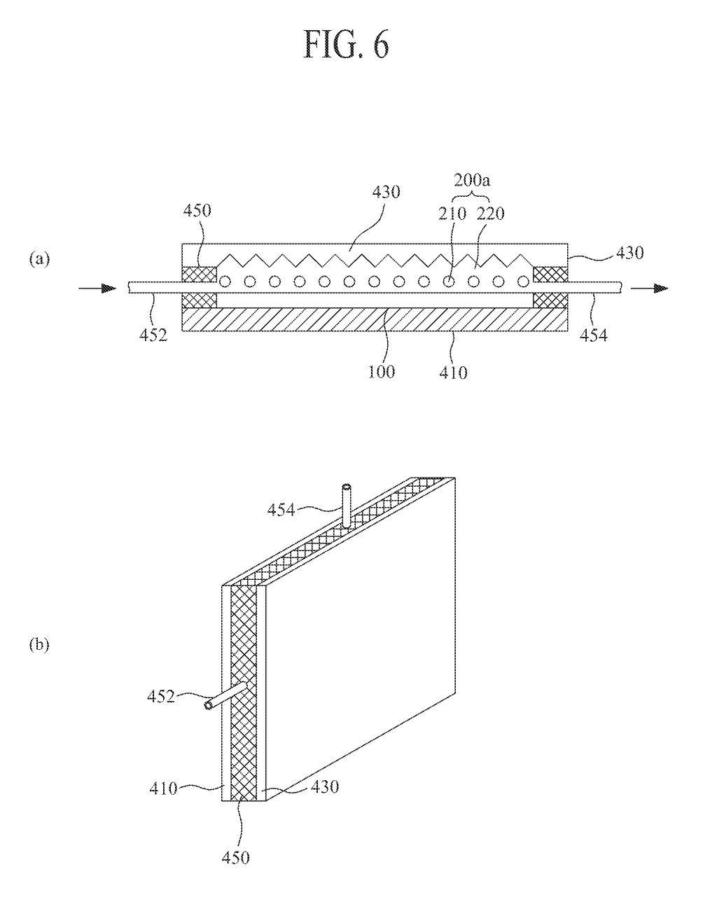

The above process of injecting the mixture 200a into the sealed inner space between the lower and upper molds 410 and 430 may be carried out via a predetermined inlet portion of the sealing element 450, which will be explained with reference to FIGS. 6A and 6B.

FIG. 6A is a cross section view illustrating the process of injecting the mixture 200a of methyl methacrylate (MMA) and light-diffusing agent according to one embodiment of the present invention. As shown in FIG. 6A, the inlet portion 452 for injection of the mixture 200a is provided at one side of the sealing element 450, and an air-discharging portion 454 is formed at the other side of the sealing element 450. Both inlet portion 452 and air-discharging portion 454 are positioned relatively higher than the substrate 100.

Under the condition that the lower and upper molds 410 and 430 fixed by the sealing element 450 are maintained horizontally, the mixture 200a is injected via the inlet portion 452 of the sealing element 450, whereby the mixture 200a is coated onto the substrate 100. Simultaneously with the mixture injection, the air remaining in the sealed inner space between the lower and upper molds 410 and 430 is discharged to the outside via the air-discharging portion 454.

FIG. 6B is a perspective view illustrating the process of injecting the mixture of methyl methacrylate (MMA) and light-diffusing agent according to another embodiment of the present invention. As shown in FIG. 6B, an inlet portion 452 for injection of the mixture is provided at one side of the sealing element 450, and an air-discharging portion 454 is formed at the other side of the sealing element 450.

Under the condition that the lower and upper molds 410 and 430 fixed by the sealing element 450 are maintained vertically the mixture is injected via the inlet portion 452 of the sealing element 450, whereby the mixture is coated onto the substrate (See ‘200a’ of FIG. 4D). Simultaneously with the mixture injection, the air remaining in the sealed inner space between the lower and upper molds 410 and 430 is discharged to the outside via the air-discharging portion 454.

Especially, in case of FIG. 6B, since the mixture (See ‘200a’ of FIG. 4D) is injected under the condition that the lower and upper molds 410 and 430 are maintained vertically, and the air-discharging portion 454 is formed at the upper side of the sealing element 450, there is less possibility that the injected mixture (See ‘200a’ of FIG. 4D) is discharged via the air-discharging portion 454, thereby enabling an easy control of the process.

As shown in FIG. 4E, the mixture with the aforementioned pattern (See ‘200a’ in FIG. 4D) is cured. The curing process may comprise forming half-cured poly methyl methacrylate (PMMA) by polymerizing the methyl methacrylate (MMA) into the poly methyl methacrylate (PMMA); and completely curing the half-cured poly methyl methacrylate (PMMA).

Accordingly, a pattern layer 200 is formed by the above curing process, wherein the pattern layer 200 is made of the mixture of poly methyl methacrylate (PMMA) 230 and light-diffusing agent 210.

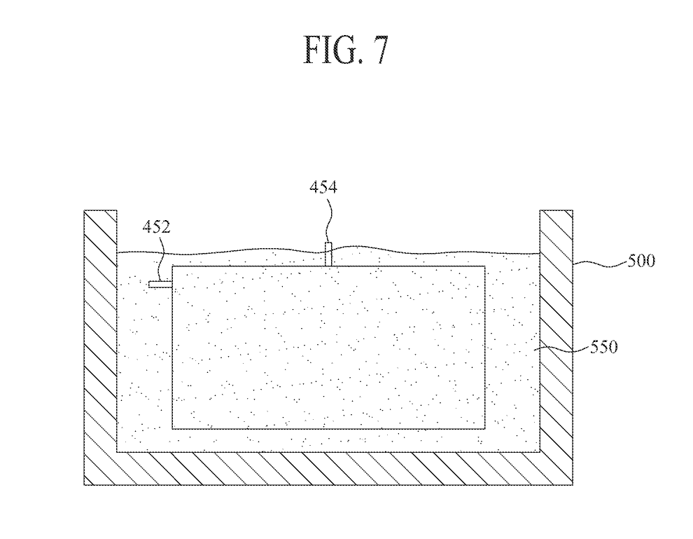

Meanwhile, the above process of polymerizing the methyl methacrylate (MMA) and the above process of completely curing the half-cured poly methyl methacrylate (PMMA) may comprise submerging the lower mold (See ‘410’ of FIG. 4E) and the upper mold (See ‘430’ of FIG. 4E) sealed by the sealing element (See ‘450’ of FIG. 4E) into a container 400 filled with liquid 550 heated to a predetermined temperature, as shown in FIG. 7.

When submerging the lower mold (See ‘410’ of FIG. 4E) and the upper mold (See ‘430’ of FIG. 4E), the end of the air-discharging portion 454 provided in the sealing element (See ‘450’ of FIG. 4E) is not submerged so that the air remaining in the sealed inner space between the lower and upper molds 410 and 430 is discharged to the outside via the air-discharging portion 454.

As shown in FIG. 4F, a predetermined optical member 1 is completed by separation of the lower mold (See ‘410’ of FIG. 4E), the upper mold (See ‘430’ of FIG. 4E), and the sealing element (See ‘450’ of FIG. 4E).

### Fourth Embodiment

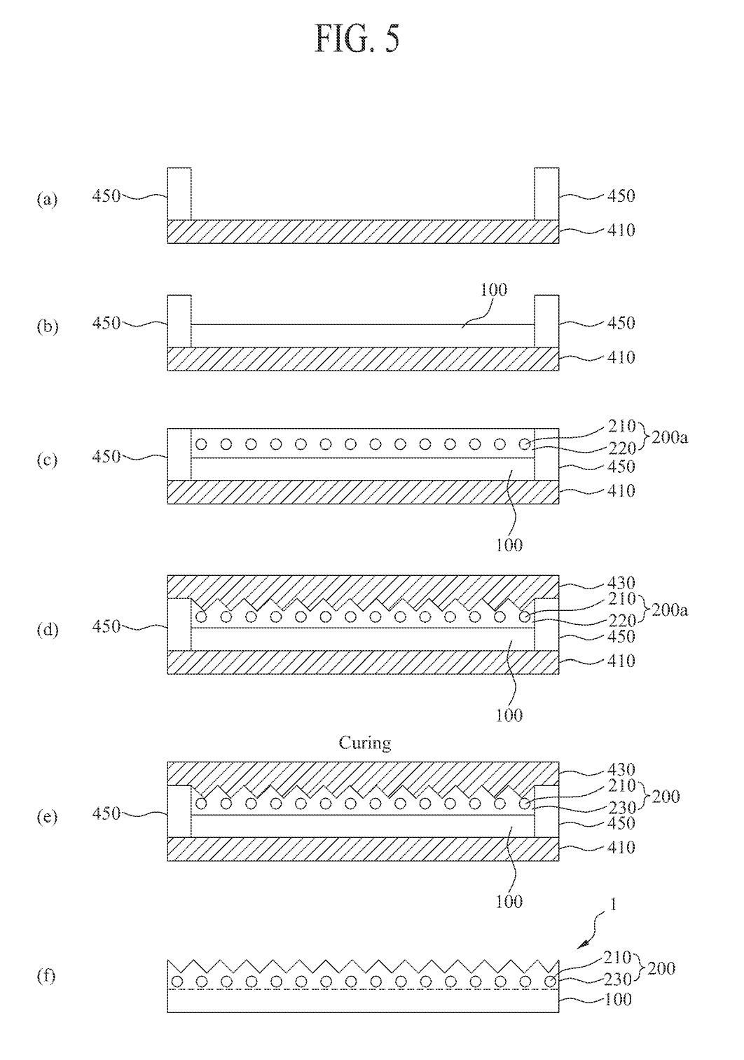

FIGS. 5A to 5F are cross section views illustrating a method of manufacturing an optical member according to the fourth embodiment of the present invention. A detailed explanation for the same parts as those of the third embodiment of the present invention will be omitted.

First, as shown in FIG. 5A, a sealing element 450 is formed in the margin of a lower mold 410.

As shown in FIG. 5B, a substrate 100 of poly methyl methacrylate (PMMA) is placed onto the lower mold 410 while being positioned inside the sealing element 450.

As shown in FIG. 5C, a mixture 200a of methyl methacrylate (MMA) 220 and light-diffusing agent 210 is dispensed onto the substrate 100 of poly methyl methacrylate (PMMA).

As shown in FIG. 5D, an upper mold 430 with a predetermined pattern is prepared. Under the condition that the predetermined pattern of the upper mold 430 faces toward the lower mold 410, the upper mold 430 is fixedly provided onto the sealing element 450.

As shown in FIG. 5E, the mixture (See ‘200a’ of FIG. 5D) is cured. That is, the curing process may comprise forming half-cured poly methyl methacrylate (PMMA) by polymerizing the methyl methacrylate (MMA) into the poly methyl methacrylate (PMMA); and completely curing the half-cured poly methyl methacrylate (PMMA).

Accordingly, a pattern layer 200 is formed by the above curing process, wherein the pattern layer 200 is made of the mixture of poly methyl methacrylate (PMMA) 230 and light-diffusing agent 210.

As shown in FIG. 5F, a predetermined optical member 1 is completed by separation of the lower mold (See ‘410’ of FIG. 5E), the upper mold (See ‘430’ of FIG. 5E), and the sealing element (See ‘450’ of FIG. 5E).

The above manufacturing method according to the present invention may be applied to the process of manufacturing various optical members, for example, light-guiding plate, diffusion sheet, and prism sheet.

1. A method of manufacturing an optical member comprising:
coating a predetermined pattern using a mixture of methyl methacrylate (MMA) and light-diffusing agent onto one surface of a substrate of poly methyl methacrylate (PMMA);
forming half-cured poly methyl methacrylate (PMMA) by polymerizing the methyl methacrylate (MMA) into the poly methyl methacrylate (PMMA); and
completely curing the half-cured poly methyl methacrylate (PMMA).

2. The method according to claim 1, wherein the process of coating the predetermined pattern using the mixture of methyl methacrylate (MMA) and light-diffusing agent comprises:
coating the mixture onto the one surface of the substrate; and
bringing a mold into contact with the mixture coated onto the substrate.

3. The method according to claim 1, wherein the process of coating the predetermined pattern using the mixture of methyl methacrylate (MMA) and light-diffusing agent comprises:
coating the mixture onto a mold with a predetermined pattern; and
depositing the substrate on the mixture.

4. A method of manufacturing an optical member comprising:
forming a sealing element in the margin of a lower mold;
placing a substrate of poly methyl methacrylate (PMMA) onto the lower mold inside the sealing element;
preparing an upper mold with a predetermined pattern, and fixedly providing the upper mold onto the sealing element under the condition that the predetermined pattern of the upper mold faces toward the lower mold;
injecting a mixture of methyl methacrylate (MMA) and light-diffusing agent into a space between the lower and upper molds to coat the mixture onto the substrate;
forming half-cured poly methyl methacrylate (PMMA) by polymerizing the methyl methacrylate (MMA) into the poly methyl methacrylate (PMMA); and
completely curing the half-cured poly methyl methacrylate (PMMA).

5. The method according to claim 4, wherein the process of injecting the mixture into the space between the lower and upper molds is carried out by injecting the mixture via an inlet portion provided at one side of the sealing element between the lower and upper molds; and air remaining in the space between the lower and upper molds is discharged via an air-discharging portion provided at the other side of the sealing element.

6. The method according to claim 5, wherein the process of injecting the mixture into the space between the lower and upper molds is carried out under the condition that the lower and upper molds are maintained vertically; and the air-discharging portion is provided at the upper side of the sealing element.

7. A method of manufacturing an optical member comprising:
forming a sealing element in the margin of a lower mold;
placing a substrate of poly methyl methacrylate (PMMA) onto the lower mold inside the sealing element;
dispensing a mixture of methyl methacrylate (MMA) and light-diffusing agent onto the substrate;
preparing an upper mold with a predetermined pattern, and fixedly providing the upper mold onto the sealing element under the condition that the predetermined pattern of the upper mold faces toward the lower mold;
forming half-cured poly methyl methacrylate (PMMA) by polymerizing the methyl methacrylate (MMA) into the poly methyl methacrylate (PMMA); and
completely curing the half-cured poly methyl methacrylate (PMMA).

8. The method according to claim 4, wherein the process of polymerizing the methyl methacrylate (MMA) into the poly methyl methacrylate (PMMA), and the process of completely curing the half-cured poly methyl methacrylate (PMMA) comprise submerging the lower and upper molds sealed by the sealing element into a container filled with a predetermined liquid.

9. The method according to claim 8, wherein the process of submerging the lower and upper molds is carried out under the condition that an end of the air-discharging portion provided in the sealing element is not submerged so as to discharge the air remaining in the sealed inner space between the lower and upper molds to the outside.

10. The method according to claim 1, wherein the process of polymerizing the methyl methacrylate (MMA) into the poly methyl methacrylate (PMMA) is carried out by a heating process maintained at 30˜100° C. temperature for 60˜120 minutes.

11. The method according to claim 1, wherein the process of completely curing the half-cured poly methyl methacrylate (PMMA) is carried out by a heating process maintained at 55˜120° C. temperature for 3˜10 minutes.

12. The method according to claim 1, wherein the light-diffusing agent is formed of a bead-shaped structure.

13. (canceled)

14. (canceled)

15. (canceled)

16. The method according to claim 7, wherein the process of polymerizing the methyl methacrylate (MMA) into the poly methyl methacrylate (PMMA), and the process of completely curing the half-cured poly methyl methacrylate (PMMA) comprise submerging the lower and upper molds sealed by the sealing element into a container filled with a predetermined liquid.

17. The method according to claim 4, wherein the process of polymerizing the methyl methacrylate (MMA) into the poly methyl methacrylate (PMMA) is carried out by a heating process maintained at 30˜100° C. temperature for 60˜120 minutes.

18. The method according to claim 7, wherein the process of polymerizing the methyl methacrylate (MMA) into the poly methyl methacrylate (PMMA) is carried out by a heating process maintained at 30˜100° C. temperature for 60˜120 minutes.

19. The method according to 4, wherein the process of completely curing the half-cured poly methyl methacrylate (PMMA) is carried out by a heating process maintained at 55˜120° C. temperature for 3˜10 minutes.

20. The method according to 7, wherein the process of completely curing the half-cured poly methyl methacrylate (PMMA) is carried out by a heating process maintained at 55˜120° C. temperature for 3˜10 minutes.

21. The method according to 4, wherein the light-diffusing agent is formed of a bead-shaped structure.

22. The method according to 7, wherein the light-diffusing agent is formed of a bead-shaped structure.
